(19) United States
(12) Patent Application Publication
(10) Pub. No.: US 2026/0080846 A1
(43) Pub. Date: Mar. 19, 2026

(54) DISPLAY DEVICE

(71) Applicant: Sharp Display Technology Corporation, Kameyama City (JP)

(72) Inventor: Haruhito YABUKI, Kameyama City (JP)

(21) Appl. No.: 19/325,749

(22) Filed: Sep. 11, 2025

(30) Foreign Application Priority Data
Sep. 13, 2024 (JP) 2024-159367

(51) Int. Cl. G09G 3/36

(52) U.S. Cl. CPC G09G 3/3677; G09G 2300/0814; G09G 2310/0286; G09G 2310/0289; G09G 2310/08

(57) ABSTRACT

A display device includes a plurality of pixels arrayed in a matrix shape having a plurality of pixel rows and a plurality of pixel columns, a plurality of scanning signal lines, a plurality of display signal lines, a scanning signal line drive circuit that supplies a scanning signal including a selection pulse for selecting any one among the plurality of pixel rows to the plurality of scanning signal lines, and a display signal line drive circuit, in which the scanning signal line drive circuit is configured to make at least one frame near-head horizontal scanning period including a first horizontal scanning period of a plurality of horizontal scanning periods present in a period from a start of a frame of an input of the scanning signal line drive circuit to a fall of a selection pulse supplied to a first scanning signal line shorter than another horizontal scanning period.

### CROSS-REFERENCE TO RELATED APPLICATIONS

This application claims the benefit of priority to Japanese Patent Application Number 2024-159367 filed on Sep. 13, 2024. The entire contents of the above-identified application are hereby incorporated by reference.

### BACKGROUND

### Technical Field

The disclosure relates to an active matrix display device, and more particularly to a display device in which a scanning signal line drive circuit that supplies a scanning signal for selecting a pixel row is integrally provided on an active matrix substrate of a display panel. For example, the disclosure relates to a liquid crystal display device (of a so-called gate-on-array (GOA) type) in which a gate drive circuit is integrally provided on an active matrix substrate of a liquid crystal display panel.

In recent years, display devices have been improved in resolution and driving speed, and it has become difficult to sufficiently charge pixels. Therefore, as a method of sufficiently charging the pixels, an overlap scan driving method has been proposed. The overlap scan driving method is disclosed in, for example, JP 2006-106394 A and WO 2018/025412. In the overlap scan driving method, since a selection pulse width of the scanning signal is made long (that is, a selection period of each scanning signal line is lengthened), the selection periods of the adjacent scanning signal lines partially overlap each other.

### SUMMARY

According to embodiments of the disclosure, solutions described in the following items are provided.

### [Item 1]

A display device includes:
a plurality of pixels arrayed in a matrix shape having a plurality of pixel rows and a plurality of pixel columns;
a plurality of scanning signal lines each associated with any one of the plurality of pixel rows;
a plurality of display signal lines each associated with any one of the plurality of pixel columns;
a scanning signal line drive circuit that supplies a scanning signal including a selection pulse for selecting any one among the plurality of pixel rows to the plurality of scanning signal lines; and
a display signal line drive circuit that supplies a display signal to the plurality of display signal lines,
in which the scanning signal line drive circuit is configured to make at least one frame near-head horizontal scanning period including a first horizontal scanning period among a plurality of horizontal scanning periods present in a period from a start of a frame of an input in the scanning signal line drive circuit to a fall of a selection pulse supplied to a first scanning signal line shorter than another horizontal scanning period.

### [Item 2]

The display device according to item 1, further includes a control circuit that supplies a control signal to the scanning signal line drive circuit and the display signal line drive circuit,
in which the control circuit includes a timing controller and a level shifter, and
the level shifter is configured to supply, to the scanning signal line drive circuit, a plurality of gate clock signals (GCK1 to GCKm) that make the at least one frame near-head horizontal scanning period shorter than the other horizontal scanning period, based on a first gate clock signal (AorB) including a high pulse at a cycle shorter than another reference horizontal scanning period of a frame in the timing controller, in at least one frame near-head reference horizontal scanning period including a first reference horizontal scanning period of a frame in the timing controller.

### [Item 3]

The display device according to item 2, in which the timing controller is configured to generate the first gate clock signal (AorB) and supply the first gate clock signal (AorB) to the level shifter.

### [Item 4]

The display device according to item 2,
in which the control circuit further includes an ORcircuit,
the timing controller is configured to generate a second gate clock signal (A) including a high pulse at a same cycle as the other reference horizontal scanning period, and a third gate clock signal (B) having at least one high pulse in a period in which the second gate clock signal is at a low level in each of the at least one frame near-head reference horizontal scanning period, and being at a low level in a period other than the at least one frame near-head reference horizontal scanning period, and
the OR circuit is configured to generate the first gate clock signal (AorB) based on the second gate clock signal (A) and the third gate clock signal (B) generated by the timing controller, and supply the first gate clock signal (AorB) to the level shifter.

### [Item 5]

The display device according to any one of items 1 to 4, in which, when the other horizontal scanning period is 1H₀, the at least one frame near-head horizontal scanning period is equal to or less than 0.5H₀.

### [Item 6]

The display device according to any one of items 1 to 5, in which the at least one frame near-head horizontal scanning period includes all of the plurality of horizontal scanning periods.

### [Item 7]

The display device according to any one of items 1 to 5, in which the at least one frame near-head horizontal scanning period includes the first horizontal scanning period and at least one horizontal scanning period that is continuous with the first horizontal scanning period.

### [Item 8]

The display device according to any one of items 1 to 7, in which, when the other horizontal scanning period is 1H, the at least one frame near-head horizontal scanning period is equal to or more than 0.3H.

### [Item 9]

The display device according to any one of items 1 to 8, in which a width of the selection pulse is longer than two horizontal scanning periods.

### [Item 10]

The display device according to any one of items 1 to 9, in which the scanning signal line drive circuit includes a shift register circuit, and the shift register circuit includes at least one dummy stage in a stage preceding a first stage that supplies a scanning signal to a scanning signal line connected to a first pixel row.

### [Item 11]

The display device according to item 10, in which an output of the at least one dummy stage is connected to at least one corresponding dummy scanning signal line.

### [Item 12]

The display device according to any one of items 1 to 11, the scanning signal line drive circuit and the plurality of scanning signal lines are formed on a same substrate.

According to the embodiments of the disclosure, there is provided a display device capable of suppressing an increase in the number of line memories even when the overlap scan driving method is adopted.

### BRIEF DESCRIPTION OF DRAWINGS

The disclosure will be described with reference to the accompanying drawings, wherein like numbers reference like elements.

FIG. 1 is a schematic view of a liquid crystal display device 100 according to an embodiment of the disclosure.

FIG. 2 is a block diagram illustrating a configuration of a control circuit 150C included in a liquid crystal display device according to a comparative example.

FIG. 3 is a timing chart of various signals in the liquid crystal display device of the comparative example.

FIG. 4 is a block diagram illustrating a configuration of a control circuit 150A included in a liquid crystal display device according to a first embodiment of the disclosure.

FIG. 5 is an example of a timing chart of various signals in the liquid crystal display device according to the first embodiment of the disclosure.

FIG. 6 is a block diagram illustrating a configuration of a control circuit 150B included in a liquid crystal display device according to a second embodiment of the disclosure.

FIG. 7 is an example of a timing chart of various signals in a liquid crystal display device according to a third embodiment of the disclosure.

FIG. 8 is an example of a timing chart of various signals in a liquid crystal display device according to a fourth embodiment of the disclosure.

FIG. 9 is an example of a timing chart of various signals in a liquid crystal display device of another comparative example.

FIG. 10 is an example of a timing chart of various signals in a liquid crystal display device according to a fifth embodiment of the disclosure.

FIG. 11 is a block diagram illustrating a configuration of a shift register circuit 130 that can be used in a gate drive circuit 120 of the liquid crystal display device according to the embodiment of the disclosure.

FIG. 12 is a timing chart of signals when the gate drive circuit 120 including the shift register circuit 130 illustrated in FIG. 11 is driven by a known method.

FIG. 13 is a timing chart of signals when the shift register circuit 130 illustrated in FIG. 11 is driven by a method of performing fast forward (high-speed scanning) of the first embodiment.

FIG. 14 is a block diagram illustrating a configuration of another shift register circuit 135 that can be used in the gate drive circuit 120 of the liquid crystal display device according to the embodiment of the disclosure.

FIG. 15 is a timing chart of signals when the gate drive circuit 120 including the shift register circuit 135 of FIG. 14 is driven by a known method.

FIG. 16 is a timing chart of signals when the shift register circuit 135 illustrated in FIG. 14 is driven by a method of performing fast forward (high-speed scanning) of the fifth embodiment.

### DESCRIPTION OF EMBODIMENTS

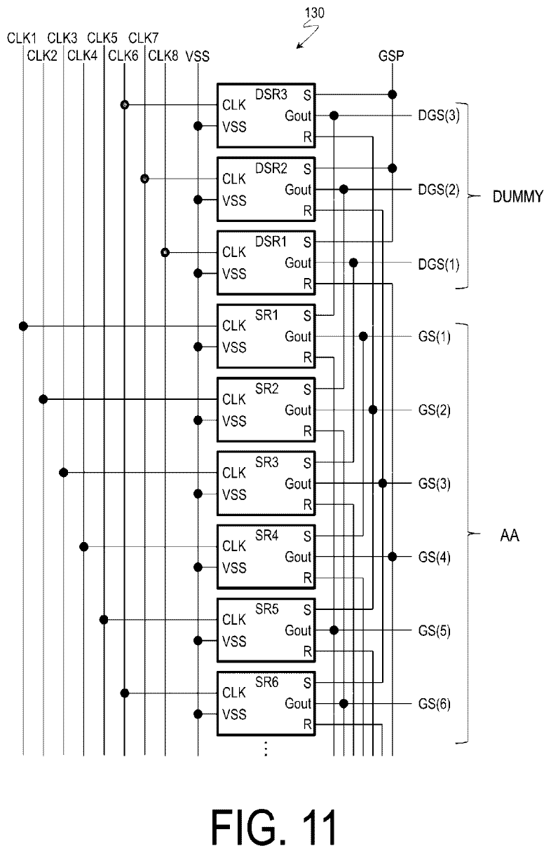

When the selection pulse (gate-on pulse) width of the scanning signal (gate scanning signal) is made long as in the overlap scan driving method, or when a dummy stage (for example, stages DSR1, DSR2, and DSR3 in FIG. 11) is provided in the gate drive circuit such as the GOA, a period from a start of a frame to an end of writing of the pixels of a first row is lengthened, and accordingly, a necessary amount of a line memory for holding a source signal (display signal) increases, which leads to an increase in cost.

Here, the frame refers to a period in which one complete image is displayed in a display area, and may be referred to as a vertical scanning period. The reciprocal of the vertical scanning period may be referred to as a vertical frequency, and for example, in the case of 120 Hz driving, 120 images are displayed per second, which may be expressed as 120 fps (120 frames/sec). A frame has a beginning and an end, and does not merely represent a length of time. The timing of the end of a frame is the same as the timing of the beginning of the next frame. The length of time of a frame may be referred to as one frame period or one vertical scanning period (1V). A period from when selection of an arbitrary pixel row (scanning line) is started in a certain frame to when selection of the pixel row (scanning line) is started in the next frame corresponds to one frame period (one vertical scanning period). One frame period includes an effective scanning period (E), which is a period from the start of selection (writing) of the first pixel row (rising of the selection pulse) to the end of selection (writing) of the last pixel row (falling of the selection pulse), and a non-effective scanning period (NE) called a retrace period. In addition, in a frame, a period from the start of selection of a certain pixel row to the start of selection of the next pixel row is referred to as one horizontal scanning period (1H).

In general, the vertical scanning period (V)=the effective scanning period (E)+the non-effective scanning period (NE), and the effective scanning period (E)=the horizontal scanning period (H)×the number of pixel rows (m). Further, the non-effective scanning period (NE)=the vertical scanning period (V)−the effective scanning period (E)=the vertical scanning period (V)−the horizontal scanning period (H)×the number of pixel rows (m). When the overlap scan driving method is adopted and a precharge period is set to, for example, 2H, the effective scanning period (E)=the horizontal scanning period (H)×the number of pixel rows (m)+2H, and the non-effective scanning period (NE)=the vertical scanning period (V)−the horizontal scanning period (H)×the number of pixel rows (m)−2H.

An object of the disclosure is to provide a display device capable of suppressing an increase in the number of line memories even when an overlap scan driving method is adopted and/or a dummy stage is provided in a gate drive circuit such as a GOA.

A display device according to an embodiment of the disclosure includes a plurality of pixels arrayed in a matrix shape having a plurality of pixel rows (m rows) and a plurality of pixel columns (n columns), a plurality of scanning signal lines (m lines) each associated with any one of the plurality of pixel rows, a plurality of display signal lines (n lines) each associated with any one of the plurality of pixel columns, a scanning signal line drive circuit that supplies a scanning signal including a selection pulse for selecting any one among the plurality of pixel rows to the plurality of scanning signal lines, and a display signal line drive circuit that supplies a display signal to the plurality of display signal lines, in which the scanning signal line drive circuit is configured to make at least one frame near-head horizontal scanning period including a first horizontal scanning period among a plurality of horizontal scanning periods present in a period from a start of a frame in an input of the scanning signal line drive circuit to a fall of a selection pulse supplied to a first scanning signal line shorter than another horizontal scanning period.

Here, the other horizontal scanning period is denoted by H₀, and the frame near-head horizontal scanning period shorter than the other horizontal scanning period H₀ is denoted by H₁. At least one frame near-head horizontal scanning period including the first horizontal scanning period among the plurality of horizontal scanning periods present in the period from the start of the frame in an input of the scanning signal line drive circuit to the fall of the selection pulse supplied to the first scanning signal line is, for example, four frame near-head horizontal scanning periods 4H₁, and when, for example, H₁=H₀/2, two horizontal scanning periods 2H₀ in a known driving method can be four horizontal scanning periods 4H₁. Therefore, four scanning lines can be scanned in a period in which only two scanning lines can be scanned in the known driving method. This may be referred to as “fast forward (high-speed scanning)”. Further, at least one frame near-head horizontal scanning period in which fast forward (high-speed scanning) is performed may be referred to as a “fast forward period (high-speed scanning period)”.

In the display device according to the embodiment of the disclosure, the frame near-head horizontal scanning period (H₁) shorter than the other horizontal scanning period (H₀) may be referred to as a “shortened horizontal scanning period (H₁)”, and the other horizontal scanning period (H₀) may be referred to as a “standard horizontal scanning period (H₀)”.

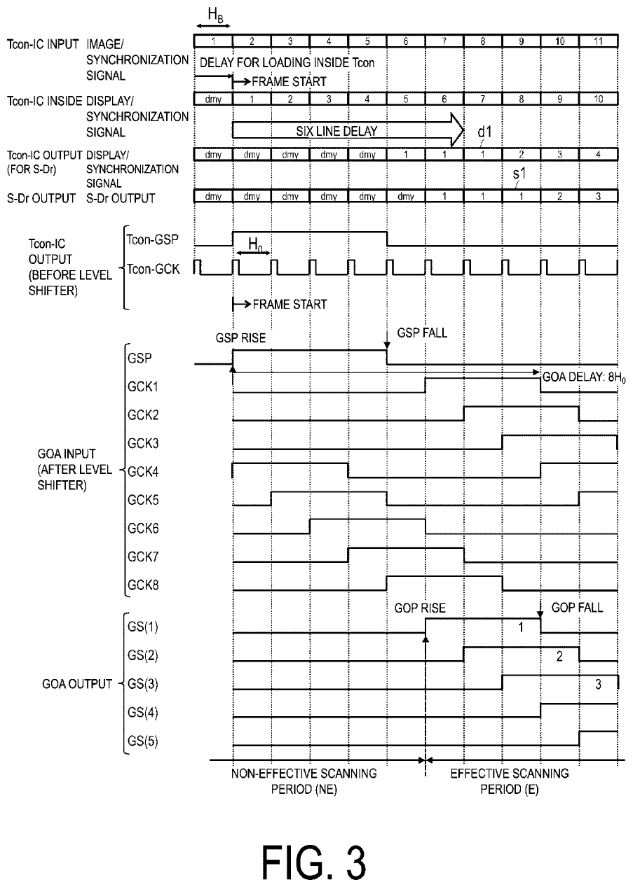

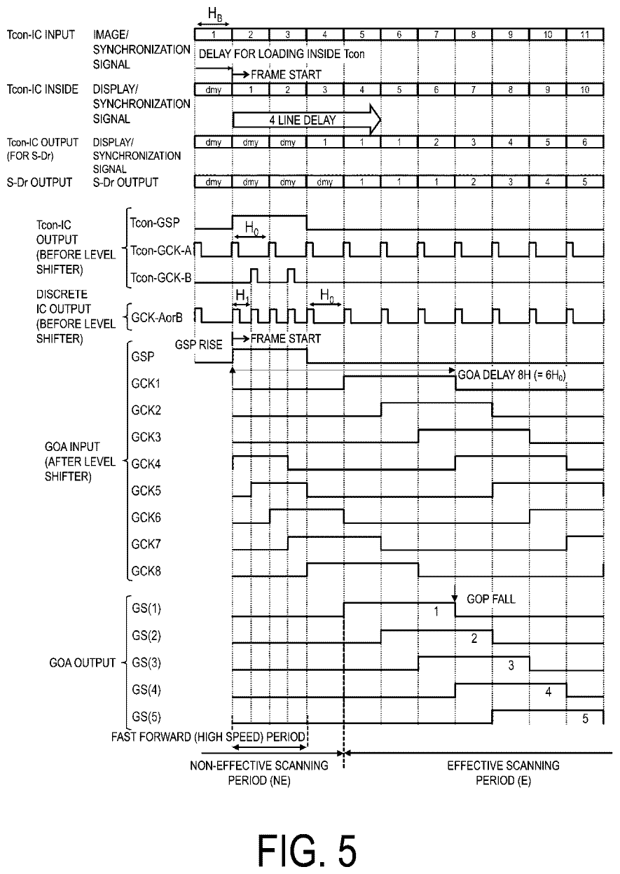

The display device includes, for example, a control circuit that supplies a control signal to the scanning signal line drive circuit and the display signal line drive circuit, and the control circuit includes a timing controller and a level shifter. As illustrated in the timing charts of FIGS. 3 and 5, a start of a “vertical scanning period (frame) in a display area” is a time point of a rise of an on-pulse (GOP of GS (1)) of a first gate signal excluding a dummy gate signal among an output of the scanning signal line drive circuit (GOA) (that is, a start of the effective scanning period (E)), and the start of the “vertical scanning period (frame) in the input of the scanning signal line drive circuit” is a rise of a gate start pulse GSP. The timing of the rise of the gate start pulse GSP is determined by the timing controller. A signal obtained by level-converting an output Tcon-GSP of the timing controller by the level shifter is GSP, and in general, the timings of Tcon-GSP and GSP are substantially the same (actually, a slight delay at the minimum necessary for level conversion occurs, but it can be regarded as an error). The timing controller determines each period based on an (input) synchronization signal, which is input together with an input image signal or included in the input image signal, according to resolution, a drive frequency, and the like of the display device. This period is referred to as each period “in the timing controller” (for example, a vertical scanning period in the timing controller and a horizontal scanning period in the timing controller). In addition, each period in the timing controller may be referred to as each reference period (for example, a reference vertical scanning period (V_{B}) and a reference horizontal scanning period (H_{B})).

All the horizontal scanning periods in the display area of the known display device that does not perform fast forward (high-speed scanning) in the display device according to the embodiment of the disclosure are equal to the reference horizontal scanning period (H_{B}). That is, setting the fast forward period to the four frame near-head horizontal scanning periods as described above corresponds to generating four horizontal scanning periods 4H₁ corresponding to two reference horizontal scanning periods 2H_{B} in the case of H₁=H_{B}/2.

In the display device according to the embodiment of the disclosure, the scanning signal line drive circuit (GOA) is configured to make at least one frame near-head horizontal scanning period (H₁) including the first horizontal scanning period among a plurality of horizontal scanning periods present in a period from the start of a frame in the input of the scanning signal line drive circuit to the fall of a selection pulse supplied to the first scanning signal line shorter than another horizontal scanning period (H₀). The other horizontal scanning period (H₀) may be the same as the reference horizontal scanning period (H_{B}). By making the other horizontal scanning period (H₀) the same as the reference horizontal scanning period (H_{B}), an advantage that a configuration of the control circuit can be simplified is obtained.

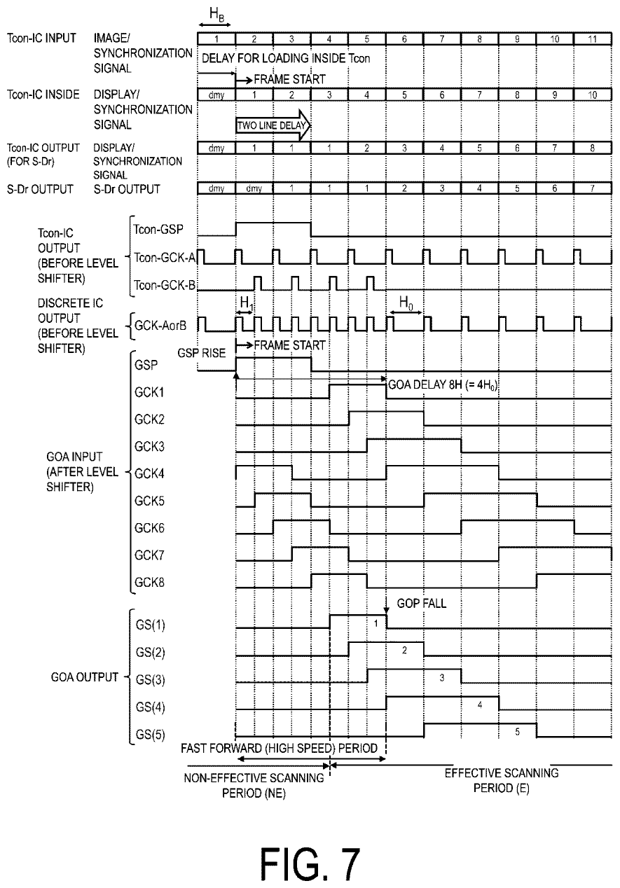

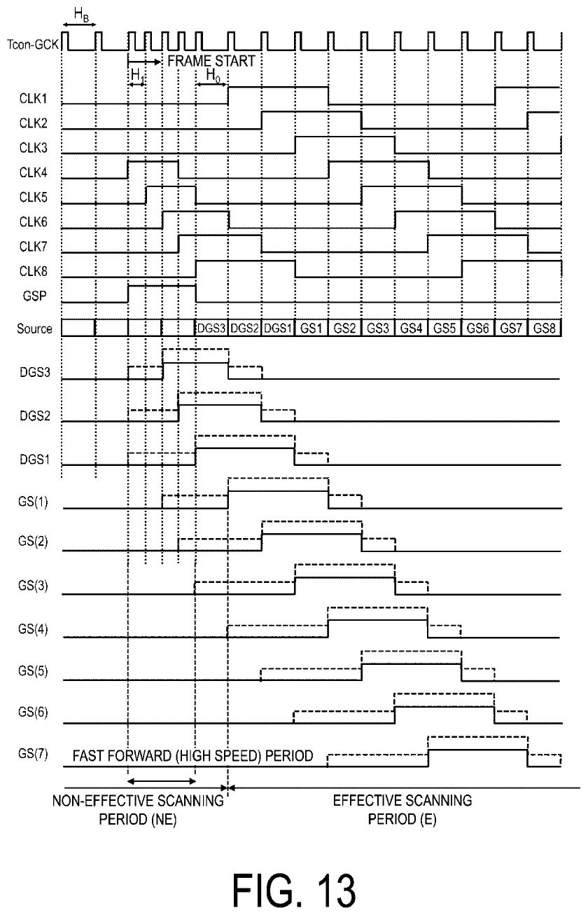

The fast forward (high-speed scanning) is performed at least in the non-effective scanning period (NE). For example, as will be described below, the fast forward may be performed only in the non-effective scanning period (NE) (for example, FIGS. 5 and 13), or may be performed in both the non-effective scanning period (NE) and the effective scanning period (E) subsequent thereto (for example, FIGS. 7, 8, 10, and 16). By performing the fast forward in the non-effective scanning period (NE) immediately before the effective scanning period (E), the memory of a timing controller (Tcon-IC) can be reduced.

In the display device according to the embodiment of the disclosure, for example, the level shifter is configured to supply, to the scanning signal line drive circuit, a plurality of gate clock signals (GCK1 to GCKm) that make at least one frame near-head horizontal scanning period of the frame in the scanning signal line drive circuit shorter than another horizontal scanning period, based on a first gate clock signal (AorB) including a high pulse at a cycle shorter than the other reference horizontal scanning period in the timing controller, in at least one frame near-head reference horizontal scanning period including a first reference horizontal scanning period in the timing controller.

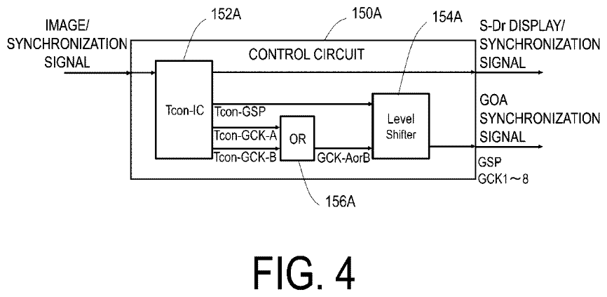

In the display device according to the embodiment of the disclosure, for example, the control circuit further includes an OR circuit, the timing controller is configured to generate a second gate clock signal (A) including a high pulse at the same cycle as the other reference horizontal scanning period, and a third gate clock signal (B) having at least one high pulse in a period in which the second gate clock signal (A) is at a low level in each of the at least one frame near-head reference horizontal scanning period and being at a low level in a period other than the at least one frame near-head reference horizontal scanning period, and the OR circuit is configured to generate a first gate clock signal (AorB) based on the second gate clock signal (A) and the third gate clock signal (B) generated by the timing controller, and supply the first gate clock signal (AorB) to the level shifter (for example, see a first embodiment and FIG. 4 described below). For example, the third gate clock signal (B) may have one high pulse in one frame near-head reference horizontal scanning period. In this case, the third gate clock signal (B) may have the same waveform as the second gate clock signal (A) and may be a signal having a phase shifted from the second gate clock signal (A). The third gate clock signal (B) may have two or more high pulses in one frame near-head reference horizontal scanning period.

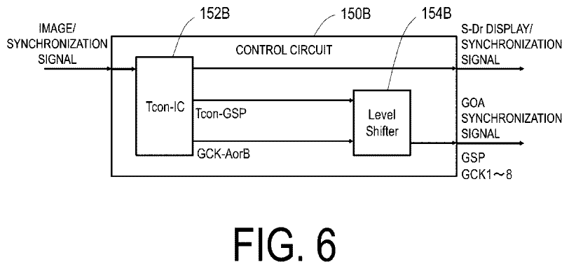

In the display device according to the embodiment of the disclosure, the timing controller may be configured to generate the first gate clock signal (AorB) and supply the first gate clock signal (AorB) to the level shifter (for example, see a second embodiment and FIG. 6 described below).

When the other horizontal scanning period is H₀, at least one frame near-head horizontal scanning period H₁ is equal to or less than 0.5H₀. Note that at least one frame near-head horizontal scanning period H₁ is preferably equal to or more than 0.1H₀. When at least one frame near-head horizontal scanning period H₁ is less than 0.1H₀, the pixel is significantly insufficiently charged. The at least one frame near-head horizontal scanning period is preferably equal to or less than five horizontal scanning periods. When the fast forward period is lengthened, the pixels in the upper part of the screen cannot be sufficiently charged, and the concern of the display quality deterioration increases. In addition, a margin of the operation stability of the GOA may be reduced.

Hereinafter, display devices according to embodiments of the disclosure will be described with reference to the accompanying drawings. The display devices according to the embodiments of the disclosure are not limited to those exemplified below.

An active matrix display device in which each pixel includes a TFT is described below as an example. In the active matrix display device of the embodiment, each of the plurality of pixels includes a display medium layer, a pair of electrodes disposed so as to face each other with the display medium layer interposed therebetween, and a TFT having a drain electrode connected to one of the pair of electrodes, the plurality of scanning signal lines are a plurality of gate bus lines, the plurality of display signal lines are a plurality of source bus lines, a gate electrode of the TFT is connected to the gate bus line associated with a pixel row including a pixel having the TFT, a source electrode of the TFT is connected to the source bus line associated with a pixel column including a pixel having the TFT, the scanning signal line drive circuit is a gate drive circuit, the scanning signal is a gate scanning signal (GS) including a gate-on pulse (GOP) for turning on the TFT as a selection pulse, the display signal line drive circuit is a source drive circuit, and the display signal is a source signal (SS).

Hereinafter, an active matrix liquid crystal display device in which a display medium layer is a liquid crystal layer will be described with reference to the drawings. Note that the liquid crystal display devices according to the embodiments of the disclosure are not limited to those exemplified below.

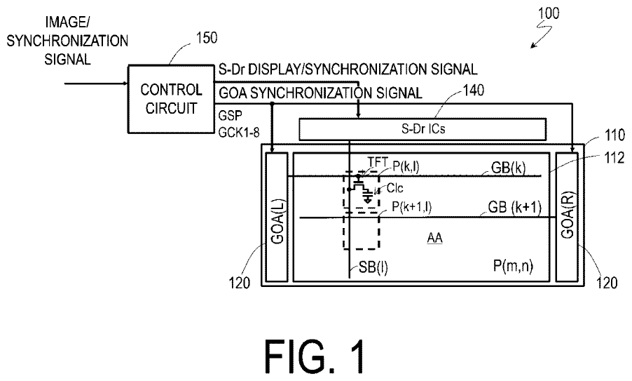

FIG. 1 is a schematic view of a liquid crystal display device 100 according to the embodiment of the disclosure.

The liquid crystal display device 100 includes a plurality of pixels P arrayed in a matrix shape having a plurality of pixel rows (m rows) and a plurality of pixel columns (n columns). The liquid crystal display device 100 is an active matrix liquid crystal display device, and includes a thin film transistor (TFT) and a liquid crystal capacitance Clc for each of the pixels P. The pixel P may further include an auxiliary capacitance Cs (not illustrated) electrically connected in parallel with the liquid crystal capacitance Clc. Here, for the sake of simplicity, the description of the auxiliary capacitance Cs is omitted. The liquid crystal capacitance Clc is formed by, for example, a pixel electrode (not illustrated) formed on an active matrix substrate 110 and a common electrode (also referred to as a counter electrode, not illustrated) disposed so as to face the pixel electrode via a liquid crystal layer (not illustrated). The common electrode is formed on a counter substrate 112 disposed opposite to the active matrix substrate 110, for example.

An area in which the plurality of pixels P are formed is referred to as an active area AA or a display area. The pixel in the k-th row and the l-th column among the pixels arrayed in the m rows and the n columns may be referred to as P(k, l). k, l, m, and n are positive integers that satisfy the relationships of 1≤k≤m and 1≤l≤n. For example, in a liquid crystal display device having a resolution of so-called 2K4K, m is equal to 2160 and n is equal to 3840×3 (when a color display pixel is constituted by an R pixel, a G pixel, and a B pixel, the “pixel” here may be referred to as a “dot”, and the “color display pixel” constituted by three “dots” may be referred to as a “pixel”). Each of the plurality of pixels has the liquid crystal capacitance Clc including a pixel electrode, and the TFT whose drain electrode is connected to the pixel electrode.

The liquid crystal display device 100 further includes a plurality of gate bus lines GB (m lines), each of which is associated with one of the plurality of pixel rows, and a plurality of source bus lines SB (n lines), each of which is associated with one of the plurality of pixel columns. The gate electrode of the TFT of each of the pixels is connected to the gate bus line GB associated with the pixel row in which the pixel is included, and the source electrode of the TFT of each of the pixels is connected to the source bus line SB associated with the pixel column in which the pixel is included.

The liquid crystal display device 100 further includes a gate drive circuit 120 that supplies the gate scanning signal including the gate-on pulse GOP that turns on the TFT to the plurality of gate bus lines GB, and a source drive circuit 140 that supplies the source signal to the plurality of source bus lines SB. Here, in an illustrated example of the gate drive circuit 120, two gate drive circuits (GOA (L), (R)) 120 are disposed on both left and right sides of the active area AA, but it is needless to say that the gate scanning signal may be supplied to all the gate bus lines from one gate drive circuit 120 disposed on either the left or right side. Note that the gate drive circuit 120 may be denoted by GOA.

The liquid crystal display device 100 is a GOA type, and the gate drive circuit 120 is formed on the active matrix substrate 110, similarly to the pixel electrode, the TFT, the plurality of source bus lines SB, and the plurality of gate bus lines GB. As is well known, the active matrix substrate 110 includes, for example, a conductive layer (metal layer), a semiconductor layer, and an insulating layer on a glass substrate, and is manufactured by a known method. The source drive circuit 140 may be mounted on the active matrix substrate 110 as a source driver IC (S-DrICs), for example, or a flexible substrate on which a source driver IC is mounted may be connected to the active matrix substrate 110.

The gate drive circuit 120 and the source drive circuit 140 are controlled by a control circuit 150. The control circuit 150 includes a timing controller (Tcon-IC) and a level shifter. The timing controller determines a reference vertical scanning period (V_{B}) and a reference horizontal scanning period (H_{B}) based on the (input) synchronization signal, which is input together with the input image signal or included in the input image signal, according to the resolution, the drive frequency, and the like of the display device. The control circuit 150 supplies a control signal necessary for each of the gate drive circuit 120 and the source drive circuit 140. The liquid crystal display device 100 further includes a power supply circuit (not illustrated) that supplies a power supply voltage necessary for each of the gate drive circuit 120 and the source drive circuit 140.

The control circuit 150 outputs a synchronization signal (horizontal synchronization signal), the gate start pulse GSP and the gate clock signal GCK to the gate drive circuit 120. Here, eight phase gate clock signals GCK1 to GCK8 are output. The control circuit 150 also outputs a synchronization signal (vertical synchronization signal) and a display signal to the source drive circuit 140.

The gate drive circuit 120 supplies the gate scanning signal so as to sequentially apply the gate-on pulse GOP for turning on the TFT to the plurality of gate bus lines GB along a scanning direction, and the source drive circuit 140 supplies the display signal to the plurality of source bus lines SB so that a gray-scale voltage to be displayed by a pixel is applied to a pixel electrode connected to the TFT turned on by the gate-on pulse GOP.

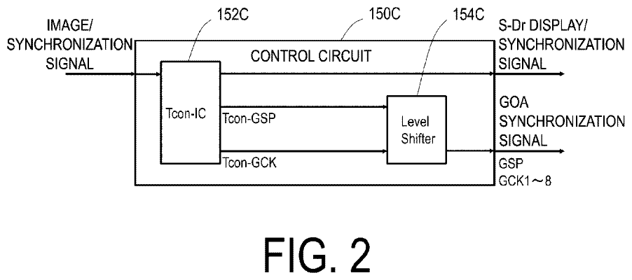

Next, a configuration of a control circuit 150C of a liquid crystal display device of a comparative example and the timing of various signals will be described with reference to FIGS. 2 and 3. The liquid crystal display device of the comparative example is driven by a known driving method in which the fast forward (high-speed scanning) is not performed. FIG. 2 is a block diagram illustrating the configuration of the control circuit 150C included in the liquid crystal display device of the comparative example, and FIG. 3 is a timing chart of various signals in the liquid crystal display device of the comparative example, and for example, a similar timing chart is described in a liquid crystal display device described in WO 2018/025412. The timing chart of FIG. 3 corresponds to the timing chart of FIG. 7 of WO 2018/025412, in which the number of phases of GCK is changed from four to eight, and the L/H duty ratio of the GCK is changed from 2:2 to 3:5.

Description will be given with reference to FIG. 2. In the control circuit 150C, a Tcon-IC 152C receives the image signal and the synchronization signal, generates a Tcon-GSP (a gate start pulse output by the Tcon-IC 152C) and a Tcon-GCK signal (a gate clock signal output by the Tcon-IC 152C), outputs the Tcon-GSP and the Tcon-GCK signal to a level shifter 154C, and outputs the display signal and the synchronization signal to the source drive circuit 140. In the liquid crystal display device of the comparative example, a horizontal scanning period H in the display area is the standard horizontal scanning period H₀, which is the same as the reference horizontal scanning period H_{B} in the Tcon-IC. The Tcon-GSP and the Tcon-GCK are digital signals, and the voltages thereof are, for example, 0 V and 3.3 V. The level shifter 154C generates the gate start pulse GSP and the gate clock signals GCK1 to GCK8 based on the input Tcon-GSP and Tcon-GCK, and outputs the gate start pulse GSP and the gate clock signals GCK1 to GCK8 to the gate drive circuit 120. These are analog signals, and the voltages thereof are, for example, 7 V and 35 V.

Description will be given with reference to FIG. 3. When the Tcon-IC loads input signals, a delay (1H_{B}) due to the one line memory occurs for recognition of the synchronization signal, recombination to an internal Bus, and the like. After that, the Tcon-IC can start generating a gate start pulse GSP (a high-level portion, a pulse width 4H₀) which is a head signal of a frame in an input of the scanning signal line drive circuit (GOA). The signals input to the Tcon-IC in FIG. 3 are illustrated by blocks for each 1H_{B}. The scanning signal line drive circuit (GOA) starts its internal operation with the rise of the gate start pulse GSP as a starting point.

In this example, the GOA requires 8H₀ from the rise of the gate start pulse GSP to the fall of the gate-on pulse GOP (high-level portion) included in a gate scanning signal GS (1) supplied to a gate bus line GB (1) connected to the first pixel row in the active area AA. Note that since the overlap scan driving method is applied here, the gate-on pulse GOP has the width of 3H₀ (the high-level period is 3H₀) including the precharge period 2H₀.

Further, since the delay of 1H₀ (d1 in FIG. 3) occurs in an S-Dr and the S-Dr outputs the voltage for the pixel during the 1H₀ period (s1 in FIG. 3), a line delay required for the Tcon-IC is 6H₀ (8H₀-1H₀-1H₀). In this way, the S-Dr output is synchronized with the gate-on pulse GOP (high-level portion) included in the gate scanning signal GS supplied to the gate bus line GB (1) connected to the first pixel row.

The GOA outputs the gate scanning signals GS (1), GS (2), . . . GS (m) based on the GSP and the GCK1 to GCK8. For example, in the case of a liquid crystal display device having a resolution of 2K4K, the gate scanning signals are up to GS (2160).

Hereinafter, a liquid crystal display device according to a first embodiment of the disclosure will be described with reference to FIGS. 4 and 5. FIG. 4 is a block diagram illustrating a configuration of a control circuit 150A included in the liquid crystal display device according to the first embodiment of the disclosure, and FIG. 5 is an example of a timing chart of various signals in the liquid crystal display device according to the first embodiment of the disclosure.

As illustrated in FIG. 4, the control circuit 150A includes a Tcon-IC 152A, a level shifter 154A, and an OR circuit 156A. The Tcon-IC 152A generates Tcon-GSP and two types of gate clocks Tcon-GCK-A and Tcon-GCK-B, and outputs a display signal and a synchronization signal to the source drive circuit 140. Tcon-GCK-A and Tcon-GCK-B are input to the OR circuit 156A, and the OR circuit 156A performs “OR” processing to generate a gate clock signal GCK-AorB and outputs the gate clock signal GCK-AorB to the level shifter 154A. The OR circuit 156A can be achieved by, for example, a relatively inexpensive external discrete IC (one). Alternatively, a Wired-OR circuit may be used instead of the discrete IC. These are digital signals, and the voltages thereof are, for example, 0 V and 3.3 V. The level shifter 154A generates the gate start pulse GSP and the gate clock signals GCK1 to GCK8 based on the input Tcon-GSP and the gate clock signal GCK-AorB, and outputs the gate start pulse GSP and the gate clock signals GCK1 to GCK8 to the gate drive circuit 120. These are analog signals, and the voltages thereof are, for example, −7 V and 35 V.

Description will be given with reference to FIG. 5. The waveform of Tcon-GCK-A is the same as that of Tcon-GCK of the comparative example. The waveform of Tcon-GCK-B is a waveform shifted in phase by 0.5H₀ from Tcon-GCK-A near the frame head (2H₀), and is constant at “L” (low level) in the portion other than near the frame head. By performing the “OR” processing on Tcon-GCK-A and Tcon-GCK-B, it is possible to generate the gate clock signal GCK-AorB having a waveform in which the cycle of the “H” pulse of GCK only near the frame head is set to 0.5H₀ (=1H₁).

When the level shifter 154A generates the signals to be output to the GOA based on the gate clock signal GCK-AorB, one horizontal scanning period of the GOA is shortened to 0.5H₀ (=1H₁) only within the frame near-head horizontal scanning period (here, a period corresponding to the pulse width of the GSP, the frame near-head reference horizontal scanning period in the timing controller (first and second reference horizontal scanning periods, periods corresponding to 1 and 2 in the second row from the top in FIG. 5)) (from the start of the frame up to 1H₀ before the rise of the gate-on pulse GOP (high-level portion) included in the gate scanning signal GS (1) supplied to the gate bus line GB (1) connected to the first pixel row), and so-called fast forward (high-speed scanning) can be performed. Note that the horizontal scanning period of an output of the Tcon-IC and an output for the S-Dr is constant at H₀ (the same as H_{B} of the signal input to the Tcon-IC).

In this way, the line delay required for the Tcon-IC can be shortened, and in this example, the line delay is 4H₀ (6H₀ -1H₀-1H₀), which is shorter than 6H₀ in the liquid crystal display device of the comparative example illustrated in FIG. 3 by 2H₀. The period in which one horizontal scanning period of GOA is shortened to 0.5H₀ (=1H₁) is up to 1H₀ before the rise of the gate-on pulse GOP (high-level portion) included in the gate scanning signal GS (1) supplied to the gate bus line GB (1) connected to the first pixel row, and thus the width of the gate scanning signal GS (1) of the GOA output is the same as the width of GOP and subsequent GS (2).

Next, description will be given with reference to FIG. 6. FIG. 6 is a block diagram illustrating a configuration of a control circuit 150B included in a liquid crystal display device according to a second embodiment of the disclosure. A timing chart of various signals in the liquid crystal display device according to the second embodiment may be the same as the timing chart of various signals in the liquid crystal display device according to the first embodiment illustrated in FIG. 5, and thus the description thereof will be omitted.

The control circuit 150B included in the liquid crystal display device according to the second embodiment is different from the control circuit 150A included in the liquid crystal display device according to the first embodiment in that a Tcon-IC 152B generates the Tcon-GSP and the GCK-AorB, and the OR circuit is not required. Therefore, the control circuit 150B can be achieved at a lower cost than the control circuit 150A.

Next, description will be given with reference to FIG. 7. FIG. 7 is an example of a timing chart of various signals in a liquid crystal display device according to a third embodiment of the disclosure. A control circuit of the liquid crystal display device according to the third embodiment may be the same as the control circuit 150A of the liquid crystal display device according to the first embodiment illustrated in FIG. 4, for example.

In the liquid crystal display device according to the third embodiment, the period of fast forward (high-speed scanning) is made longest near the head of the frame. In the timing chart of various signals in the liquid crystal display device according to the first embodiment illustrated in FIG. 5, one horizontal scanning period of the GOA is shortened to 0.5H₀ (=1H₁) only within the frame near-head horizontal scanning period (frame near-head reference horizontal scanning period in the timing controller (here, the first and second reference horizontal scanning periods, periods corresponding to 1 and 2 in the second row from the top in FIG. 5)) (from the start of the frame up to 1H₀ before the rise of the gate-on pulse GOP (high-level portion) included in the gate scanning signal GS (1) supplied to the gate bus line GB (1) connected to the first pixel row). In contrast, in the liquid crystal display device of the third embodiment, one horizontal scanning period of the GOA is shortened to 0.5H₀ (=1H₁) only within the frame near-head horizontal scanning period (frame near-head reference horizontal scanning period in the timing controller (here, first to fourth reference horizontal scanning periods, periods corresponding to 1 to 4 in the second row from the top in FIG. 7)) from the start of the frame to the fall of the gate-on pulse GOP (high-level portion) included in the gate scanning signal GS (1) supplied to the gate bus line GB (1) connected to the first pixel row. As a result, in the liquid crystal display device according to the third embodiment, the line delay required for the Tcon-IC is reduced to 2H₀ (4H₀-1H₀-1H₀).

In this manner, when the period in which one horizontal scanning period of the GOA is shortened (may be referred to as a fast forward period) is lengthened, the amount of reduction of the line memory increases, and thus, an advantage of cost reduction and/or an advantage of an increase in the number of options of the Tcon-IC can be obtained. On the other hand, when the fast forward period is lengthened, the pixels in the upper part of the screen (for example, the first pixel row to the third pixel row) cannot be sufficiently charged, and the concern of the display quality deterioration increases. In addition, the margin of the operation stability of the GOA may be reduced.

In FIG. 7, the widths of GOP of the gate scanning signals GS (1), GS (2), and GS (3) of the GOA output are smaller than the widths of GOP of GS (4) and subsequent GS, the charging time is shortened, and the effect of the overlap scan driving method is reduced. However, since the first to third pixel rows are located at the ends of the screen and are therefore inconspicuous, and the charging time is shorter in the order from the first pixel row to the third pixel row and is therefore inconspicuous, a problem is less likely to occur in practical use. However, since it is difficult to shorten one horizontal scanning period (1H₀) of the Tcon-IC output (for S-Dr), the fast forward period is preferably set to a period until the fall of the gate-on pulse GOP (high-level portion) included in the gate scanning signal GS (1) supplied to the gate bus line GB (1) connected to the first pixel row.

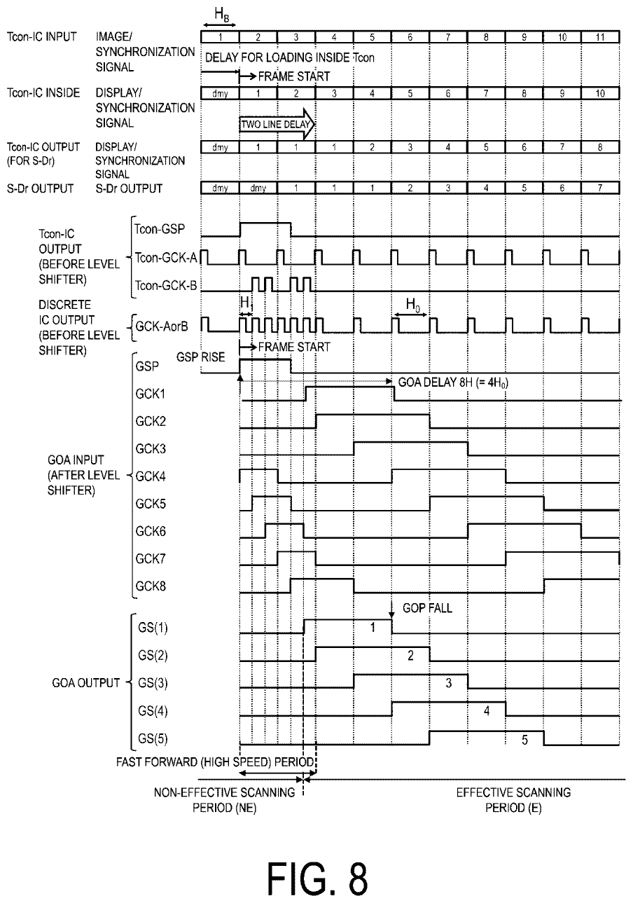

Next, description will be given with reference to FIG. 8. FIG. 8 is an example of a timing chart of various signals in a liquid crystal display device according to a fourth embodiment of the disclosure. A control circuit of the liquid crystal display device according to the fourth embodiment may be the same as the control circuit 150A of the liquid crystal display device according to the first embodiment illustrated in FIG. 4, for example.

In the liquid crystal display device according to the fourth embodiment, a fast forward speed is set to be higher than that of the liquid crystal display device according to the first embodiment (the first embodiment: double speed, the fourth embodiment: triple speed). That is, in the liquid crystal display device according to the first embodiment, one horizontal scanning period in the display area (that is, of GOA) is shortened to 0.5H₀ (=1H₁), whereas in the liquid crystal display device according to the fourth embodiment, the one horizontal scanning period is shortened to 0.33H₀ (=1H₁) (see Tcon-GCK-B in FIG. 8). As in the liquid crystal display device according to the first embodiment, the fast forward period is only the frame near-head reference horizontal scanning period (the first and second reference horizontal scanning periods) in the timing controller.

In the liquid crystal display device according to the fourth embodiment, the line delay required for the Tcon-IC is reduced to 2H₀ (4H₀-1H₀-1H₀). In the liquid crystal display device according to the third embodiment, the line delay required for the Tcon-IC is also reduced to 2H₀, but as described above, the widths of GOP of the gate scanning signals GS (1), GS (2), and GS (3) of the GOA output are smaller than the widths of GOP of GS (4) and the subsequent GS, and the charging time is shortened. In contrast, in the liquid crystal display device according to the fourth embodiment, only the width of GOP of the gate scanning signal GS (1) of the GOA output is smaller than the widths of GOP of GS (2) and subsequent GS. Therefore, the influence of deterioration in display quality due to fast forward is smaller in the liquid crystal display device according to the fourth embodiment. However, the liquid crystal display device according to the fourth embodiment has a faster speed in fast forward than the liquid crystal display device according to the third embodiment, and thus has a smaller operation margin.

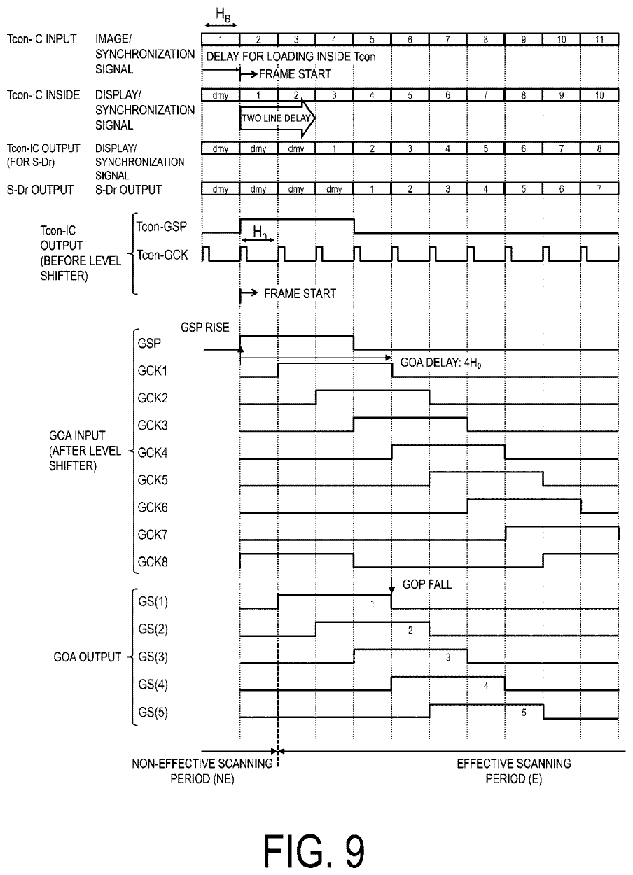

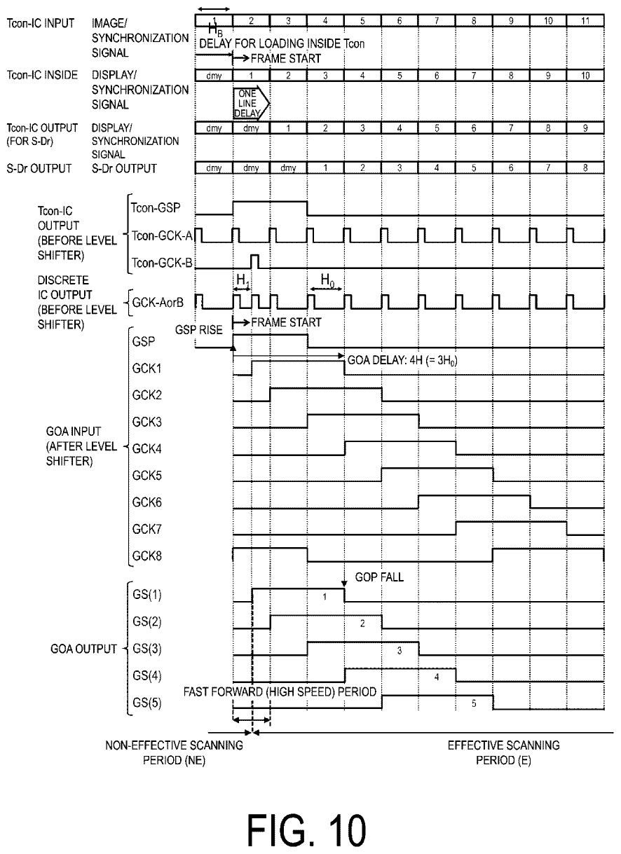

Next, description will be given with reference to FIGS. 9 and 10. FIG. 9 is an example of a timing chart of various signals in a liquid crystal display device of another comparative example, and FIG. 10 is an example of a timing chart of various signals in a liquid crystal display device according to a fifth embodiment of the disclosure. A control circuit of the liquid crystal display device according to the fifth embodiment may be the same as the control circuit 150A of the liquid crystal display device according to the first embodiment illustrated in FIG. 4, for example.

In the timing chart of the comparative example illustrated in FIG. 3, the GOA delay (the period from the rise of the GSP pulse to the fall of GOP of the gate scanning signal GS (1)) is 8H₀, whereas FIG. 9 illustrates an example in which the GOA delay is 4H₀.

In the timing chart illustrated in FIG. 3, the output for S-Dr of the Tcon-IC is the same display signal as the display signal supplied to the first pixel row for two lines for precharging the first pixel row (two-line copy). Therefore, in the output for S-Dr of the Tcon-IC in FIG. 3, a signal to be supplied to the first pixel row is supplied in fifth, sixth, and seventh reference horizontal scanning periods (periods corresponding to 5 to 7 in the second row from the top in FIG. 3) in the timing controller (the output for S-Dr of the Tcon-IC in FIG. 3 is denoted as “1” in the fifth, sixth, and seventh reference horizontal scanning periods, which indicates that the same signal as a source signal SS1 supplied in the seventh reference horizontal scanning period is supplied to two lines of the fifth and sixth reference horizontal scanning periods). In contrast, in the timing chart illustrated in FIG. 9, a line copy is not used. Whether or not to use the line copy is determined mainly based on a source time constant of the panel and target display quality.

In the liquid crystal display device of the other comparative example illustrated in FIG. 9, the horizontal scanning period H is always constant at the standard horizontal scanning period H₀, which is the same as the reference horizontal scanning period H_{B} in the Tcon-IC, in all of the output of the Tcon-IC, the output to the S-Dr, and the input/output to the GOA. The line delay required for the Tcon-IC is 2H₀ (4H₀-1H₀-1H₀).

Next, FIG. 10 is referred. FIG. 10 is an example of a timing chart of various signals in the liquid crystal display device according to the fifth embodiment of the disclosure. The control circuit of the liquid crystal display device according to the fifth embodiment may be the same as the control circuit 150A of the liquid crystal display device according to the first embodiment illustrated in FIG. 4, for example.

In the liquid crystal display device according to the fifth embodiment, the period of fast forward (high-speed scanning) is shortened near the head of the frame. In the timing chart of various signals in the liquid crystal display device according to the fifth embodiment illustrated in FIG. 10, one horizontal scanning period of the GOA is shortened to 0.5H₀ (=1H₁) only within the frame near-head horizontal scanning period (here, the frame near-head reference horizontal scanning period (the first reference horizontal scanning period, a period corresponding to 1 in the second row from the top in FIG. 10) in the timing controller).

In the liquid crystal display device according to the fifth embodiment, the line delay required for the Tcon-IC is reduced to 1H₀ (3H₀-1H₀-1H₀). In the liquid crystal display device according to the fifth embodiment, only the width of GOP of the gate scanning signal GS (1) of the GOA output is smaller than the widths of GOP of GS (2) and subsequent GS. Therefore, the charging time is shortened only for the first pixel row, and the effect of the overlap scan driving method is reduced.

However, since the first pixel row is located at the end of the screen and is therefore inconspicuous, a problem is unlikely to occur in practical use.

As the gate drive circuit 120 of the liquid crystal display device according to the embodiment of the disclosure, for example, a gate drive circuit described in US 2022/0208137 A can be suitably used. The entire contents of the disclosure of US 2022/0208137 A are incorporated in the present specification by reference.

A shift register circuit 130 illustrated in FIG. 11 can be used for the gate drive circuit 120 of the liquid crystal display device according to the embodiment of the disclosure.

FIG. 11 is a block diagram illustrating a configuration of the shift register circuit 130 used in the gate drive circuit 120 of the liquid crystal display device according to the first embodiment of the disclosure. Note that CLK1 to CLK8 in FIGS. 11 to 16 below represent the same signals as GCK1 to GCK8 in FIGS. 1 to 10.

The gate drive circuit 120 includes, for example, the shift register circuit 130 illustrated in FIG. 11. The shift register circuit 130 includes a plurality of stages (may be referred to as unit circuits or shift circuits) SR1, SR2, and SR3.

A plurality of input signals are supplied from a control circuit (for example, the control circuit 150 in FIG. 1) to the gate drive circuit 120 via a plurality of input signal lines. Here, the input signals are the clock signals CLK1 to CLK8 and a reference voltage signal Vss, and the input signal lines thereof may be referred to as clock signal lines CLK1 to CLK8 and a reference voltage signal line Vss, respectively. The clock signal CLK, the reference voltage signal Vss, a Set signal S, and a Reset signal R are input to each stage of the shift register circuit 130. Signals generated at other stages are used as the Set signal S and the Reset signal R. The gate scanning signal GS is output from each stage of the shift register circuit 130 to the gate bus line GB corresponding to each pixel row. In FIG. 11, a gate signal corresponding to the k-th pixel row is denoted by GS (k), and the k-th stage of the shift register circuit 130 is denoted by SRk. Note that the same reference numerals are used to denote terminals that output or receive signals and signals that are output from or input to the terminals.

The shift register circuit 130 illustrated in FIG. 11 has three dummy stages DSR3, DSR2, and DSR1 in a stage preceding a first stage SR1 that supplies a gate signal GS (1) to the gate bus line GB (1) connected to the first pixel row. Dummy gate signals DGS (3), DGS (2), and DGS (1) are output from an output terminal Gout of the dummy stages DSR3, DSR2, and DSR1, respectively. The output terminal Gout of each of the dummy stages DSR3, DSR2, and DSR1 may be connected to, for example, a dummy bus line or may not be connected to anything.

The output terminal Gout of the third dummy stage DSR3 is connected to a dummy gate signal terminal DGS (3) and also to a Set signal terminal S of the first stage SR1. The output terminal Gout of the second dummy stage DSR2 is connected to a dummy gate signal terminal DGS (2) and also to a Set signal terminal S of a second stage SR2. The output terminal Gout of the first dummy stage DSR1 is connected to a dummy gate signal terminal DGS (1) and also to a Set signal terminal S of a third stage SR3.

The shift register circuit 130 operates in the following flow, and sequentially outputs the gate signals GS (1 to m) to the gate bus lines GB (1 to m), thereby sequentially scanning the gate bus lines GB (1 to m).

The gate start pulse GSP is input to a Set signal terminal S of the third dummy stage DSR3, and the gate clock signal CLK6 is input to a gate clock signal terminal CLK. When the gate start pulse GSP (high level) is input and then the high level of the gate clock signal CLK6 is input, a gate open pulse GOP (high level) is output from the output terminal Gout of the third dummy stage DSR3 (third dummy gate signal DGS (3)).

When the gate open pulse GOP (high level) is output from the output terminal Gout of the third dummy stage DSR3, the high level is input to the Set signal terminal S of the first stage SR1. Thereafter, when the high level of the clock signal CLK1 is input to the first stage SR1, the gate open pulse GOP (high level) is output from an output terminal Gout of the first stage SR1 (first gate signal GS (1)).

When the gate open pulse GOP (high level) is output from the output terminal Gout of the first stage SR1, the high level is input to a SET signal terminal S of a fourth stage SR4. Thereafter, when the high level of the clock signal CLK4 is input to the fourth stage SR4, the gate open pulse GOP (high level) is output from an output terminal Gout of the fourth stage SR4 (fourth gate signal GS (4)).

The gate start pulse GSP is input to a Set signal terminal S of the second dummy stage DSR2, and the gate clock signal CLK7 is input to the gate clock signal terminal CLK. When the gate start pulse GSP (high level) is input and then the high level of the gate clock signal CLK7 is input, the gate open pulse GOP (high level) is output from the output terminal Gout of the second dummy stage DSR2 (second dummy gate signal DGS (2)).

When the gate open pulse GOP (high level) is output from the output terminal Gout of the second dummy stage DSR2, the high level is input to a SET signal terminal S of the second stage SR2. Thereafter, when the high level of the clock signal CLK2 is input to the second stage SR2, the gate open pulse GOP (high level) is output from an output terminal Gout of the second stage SR2 (second gate signal GS (2)).

When the gate open pulse GOP (high level) is output from the output terminal Gout of the second stage SR2, the high level is input to a SET signal terminal S of a fifth stage SR5. Thereafter, when the high level of the clock signal CLK5 is input to the fifth stage SR5, the gate open pulse GOP (high level) is output from an output terminal Gout of the fifth stage SR5 (fifth gate signal GS (5)).

When the gate open pulse GOP (high level) is output from the output terminal Gout of the second stage SR2, the high level is input to a Reset signal terminal R of the third dummy stage DSR3. When the high level is input to the Reset signal terminal R of the third dummy stage DSR3, the third dummy gate signal DGS (3) output from the output terminal Gout of the third dummy stage DSR3 becomes the low level.

Hereinafter, the shift register circuit 130 operates in the same manner according to the connection relationship between each stage and each signal line illustrated in FIG. 11.

The shift register circuit 130 has the three dummy stages DSR3, DSR2, and DSR1 in a stage preceding the first stage that supplies the gate signal GS (1) to the gate bus line corresponding to the first pixel row of the active area (display area) AA, and thus can have the following advantages.

The waveforms of the dummy gate signals DGS (3), DGS (2), and DGS (1) output from the three dummy stages DSR3, DSR2, and DSR1 may be slightly different from the waveforms of the gate signals GS (1), GS (2), and GS (3) supplied to the first, second, and third gate bus lines GB of the active area AA. The dummy stage is provided so that the difference in the waveforms does not affect the display.

For example, the signals input to the SET signal terminals S of the three dummy stages DSR3, DSR2, and DSR1 are the gate start pulse GSP output from the control circuit 150, whereas the signals input to the SET signal terminals S of the first, second, and third stages SR1, SR2, and SR3 are the signals (dummy gate signals DGS (1 to 3)) output from the output terminals Gout of the dummy stages DSR3, DSR2, and DSR1. Therefore, there is a possibility that the waveforms of the signals (dummy gate signals DGS (1 to 3)) output from the output terminal Gout of the dummy stages DSR3, DSR2, and DSR1 are slightly different from the waveforms of the signals (gate signals GS (1 to 3)) output from the output terminal Gout of the first, second, and third stages SR1, SR2, and SR3. Therefore, when the signals (dummy gate signals DGS (1 to 3)) output from the output terminal Gout of the dummy stages DSR3, DSR2, and DSR1 are output to the gate bus lines GB in the active area, the display quality of the three pixel rows may be different from that of the other pixel rows.

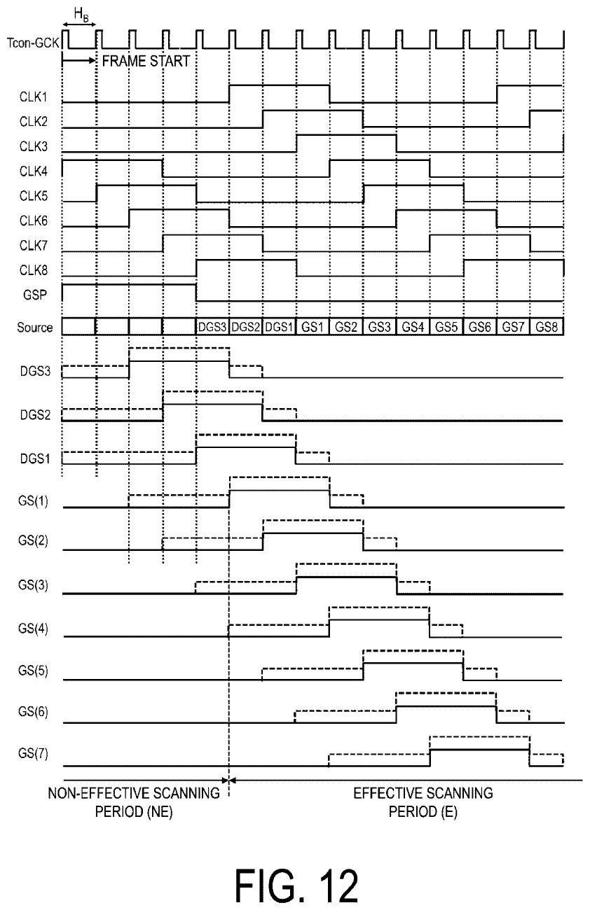

FIG. 12 is a timing chart of signals when the shift register circuit 130 illustrated in FIG. 11 is driven by a known method in which fast forward (high-speed scanning) is not performed.

As described above, the use of the shift register circuit 130 illustrated in FIG. 11 can prevent the GOA delay from adversely affecting the display. However, when the driving is performed by the known driving method, the GOA delay (from the rise ↑ of the GSP to the fall ↓ of the gate open pulse (high level) of the first gate signal GS (1)) is 8H₀, therefore, there is a problem that the GOA delay is large.

FIG. 13 is a timing chart of signals when the shift register circuit 130 illustrated in FIG. 11 is driven by the method of performing the fast forward (high-speed scanning) according to the first embodiment. In this manner, the fast forward of the first embodiment can be performed using the shift register circuit 130, and the GOA delay (from the rise ↑ of the GSP to the fall ↓ of the gate open pulse (high level) of the first gate signal GS (1)) can be set to 6H₀.

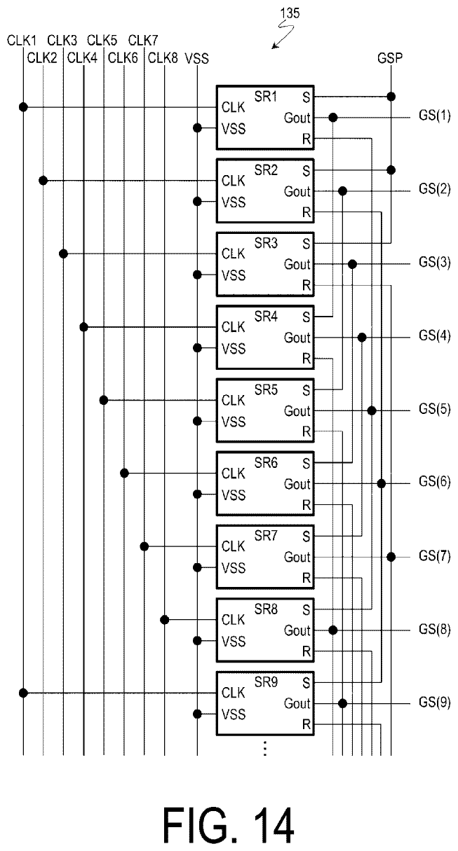

FIG. 14 is a block diagram illustrating a configuration of another shift register circuit 135 that can be used in the gate drive circuit 120 of the liquid crystal display device according to the embodiment of the disclosure. The shift register circuit 135 illustrated in FIG. 14 has the same structure and operates in the same manner as the shift register circuit 130 illustrated in FIG. 11, except that the dummy stage is not provided. Therefore, the waveforms of the signals (gate signals GS (1 to 3)) output from the output terminals Gout of the first, second, and third stages SR1, SR2, and SR3 may be slightly different from the waveforms of the signals (gate signals GS (4 to 6)) output from the output terminals Gout of the fourth, fifth, and sixth stages SR4, SR5, and SR6, and the influence may cause deterioration in display quality. However, the influence is limited to three pixel rows, and thus, there is no problem depending on the application.

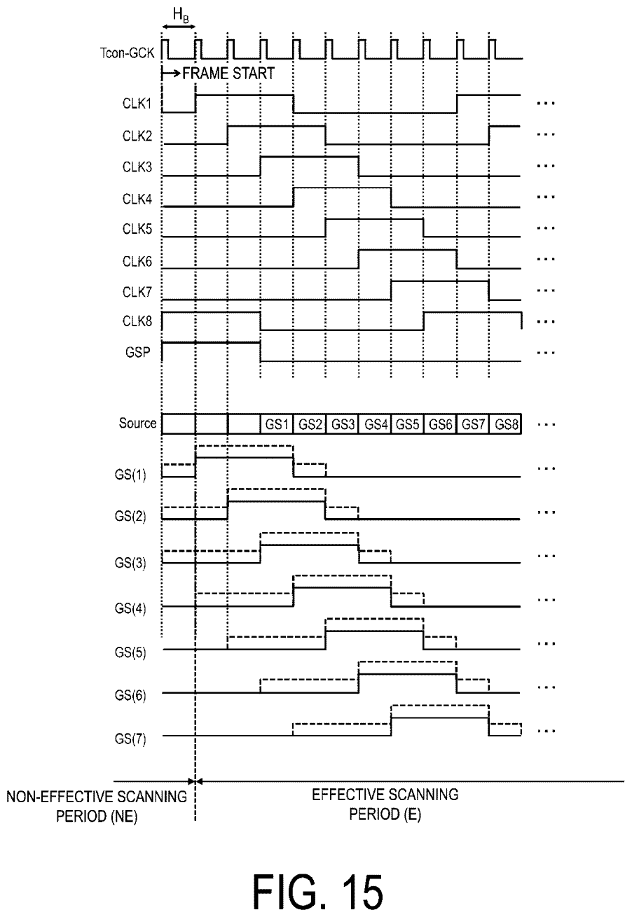

FIG. 15 is a timing chart of signals when the shift register circuit 135 illustrated in FIG. 14 is driven by a known method in which fast forward (high-speed scanning) is not performed.

As described above, when the shift register circuit 135 illustrated in FIG. 14 is used, since there is no dummy stage, the GOA delay (from the rise ↑ of the GSP to the fall ↓ of the gate open pulse (high level) of the first gate signal GS (1)) can be shortened to 4H₀ when driven by the known driving method.

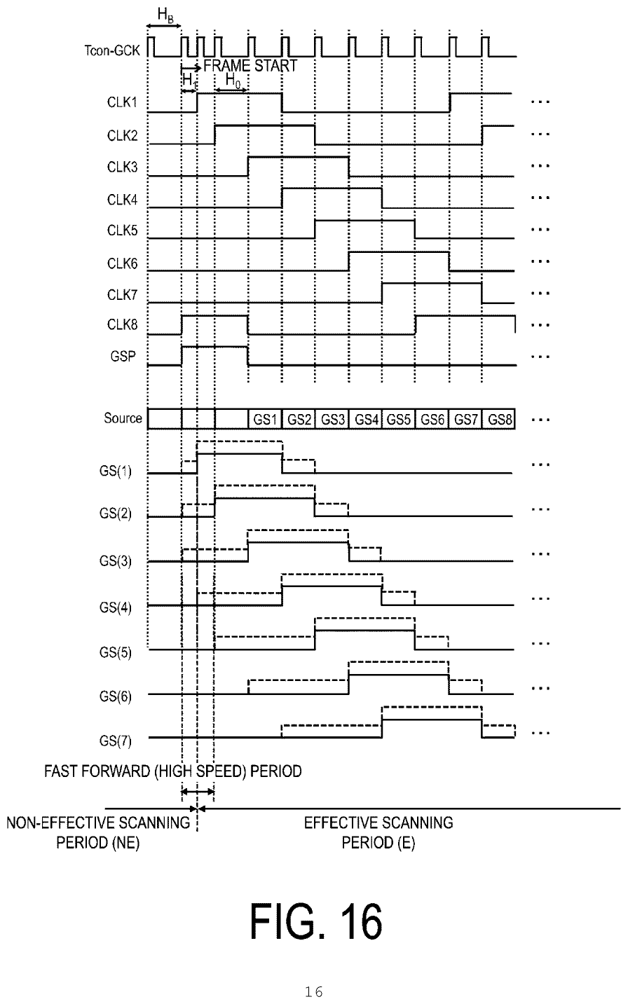

FIG. 16 is a timing chart of signals when the shift register circuit 135 illustrated in FIG. 14 is driven by the method of performing fast forward (high-speed scanning) according to the fifth embodiment. In this manner, the fast forward of the fifth embodiment can be performed using the shift register circuit 135, and the GOA delay (from the rise ↑ of the GSP to the fall ↓ of the gate open pulse (high level) of the first gate signal GS (1)) can be set to 3H₀.

As described above, in the liquid crystal display device according to the embodiment of the disclosure, the GOA delay can be shortened, and therefore, the delay of the display signal (source signal) can also be shortened. Therefore, the line memories can be reduced. In addition, the GOA can be driven using the Tcon-IC for GCOF with a short delay. The Tcon-IC for GCOF is advantageous in that it is lower in cost and easier to obtain than the Tcon-IC for GOA.

### INDUSTRIAL APPLICABILITY

The liquid crystal display device according to the embodiment of the disclosure can be widely used for a large and/or high-resolution liquid crystal display device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a plurality of pixels arrayed in a matrix shape having a plurality of pixel rows and a plurality of pixel columns;
a plurality of scanning signal lines each associated with any one of the plurality of pixel rows;
a plurality of display signal lines each associated with any one of the plurality of pixel columns;
a scanning signal line drive circuit that supplies a scanning signal including a selection pulse for selecting any one among the plurality of pixel rows to the plurality of scanning signal lines; and
a display signal line drive circuit that supplies a display signal to the plurality of display signal lines,
wherein the scanning signal line drive circuit is configured to make at least one frame near-head horizontal scanning period including a first horizontal scanning period among a plurality of horizontal scanning periods present in a period from a start of a frame of an input of the scanning signal line drive circuit to a fall of a selection pulse supplied to a first scanning signal line shorter than another horizontal scanning period.

2. The display device according to claim 1, further comprising:
a control circuit that supplies a control signal to the scanning signal line drive circuit and the display signal line drive circuit,
wherein the control circuit includes a timing controller and a level shifter, and
the level shifter is configured to supply, to the scanning signal line drive circuit, a plurality of gate clock signals that make the at least one frame near-head horizontal scanning period shorter than the other horizontal scanning period, based on a first gate clock signal including a high pulse at a cycle shorter than another reference horizontal scanning period in the timing controller, in at least one frame near-head reference horizontal scanning period including a first reference horizontal scanning period of a frame in the timing controller.

3. The display device according to claim 2,
wherein the timing controller is configured to generate the first gate clock signal and supply the first gate clock signal to the level shifter.

4. The display device according to claim 2,
wherein the control circuit further includes an OR circuit,
the timing controller is configured to generate a second gate clock signal including a high pulse at a cycle identical to the other reference horizontal scanning period, and a third gate clock signal having at least one high pulse in a period in which the second gate clock signal is at a low level in each of the at least one frame near-head reference horizontal scanning period, and being at a low level in a period other than the at least one frame near-head reference horizontal scanning period, and
the OR circuit is configured to generate the first gate clock signal based on the second gate clock signal and the third gate clock signal generated by the timing controller, and supply the first gate clock signal to the level shifter.

5. The display device according to claim 1,
wherein, when the other horizontal scanning period is 1H₀, the at least one frame near-head horizontal scanning period is equal to or less than 0.5H₀.

6. The display device according to claim 1,
wherein the at least one frame near-head horizontal scanning period includes all of the plurality of horizontal scanning periods.

7. The display device according to claim 1,
wherein the at least one frame near-head horizontal scanning period includes the first horizontal scanning period and at least one horizontal scanning period that is continuous with the first horizontal scanning period.

8. The display device according to claim 1,
wherein, when the other horizontal scanning period is 1H₀, the at least one frame near-head horizontal scanning period is equal to or more than 0.3H₀.

9. The display device according to claim 1,
wherein a width of the selection pulse is longer than two horizontal scanning periods.

10. The display device according to claim 1,
wherein the scanning signal line drive circuit includes a shift register circuit, and the shift register circuit includes at least one dummy stage in a stage preceding a first stage that supplies a scanning signal to a scanning signal line connected to a first pixel row.

11. The display device according to claim 10,
wherein an output of the at least one dummy stage is connected to at least one corresponding dummy scanning signal line.

12. The display device according to claim 1,
wherein the scanning signal line drive circuit and the plurality of scanning signal lines are formed on an identical substrate.
